(19) United States
(12) Patent Application Publication
(10) Pub. No.: US 2008/0208675 A1
(43) Pub. Date: Aug. 28, 2008

(54) Directory assistance with SMS and data support

(75) Inventors: Scott Wolmuth, Santa Rosa, CA (US); Scott A. Kliger, Franklin, MI (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Jingle Networks, Inc.

(21) Appl. No.: 11/981,684

(22) Filed: Oct. 31, 2007

Related U.S. Application Data
(63) Continuation-in-part of application No. 11/728,189, filed on Mar. 23, 2007.
Application No. 11/728,189 is a continuation of application No. 10/063,990, filed on May 31, 2002, now Pat. No. 7,212,615.

(51) Int. Cl. G06Q 30/00; G06F 17/30; G06F 7/10

(52) U.S. Cl. 705/10; 705/14; 707/3; 707/E17.014; 707/E17.009

(57) ABSTRACT

The current invention is a system for providing directory assistance service in which a user sends a request to the system and the system will, based on the request, return one or more advertisements. The user may select one of the advertisements, which may be in a visible or audible form. The request, and the advertisement, may be transmitted by Short Message Service (SMS). Additionally, the request may be in one form, such as speech, with the advertisement provided by another, such as text. The advertisements are selected from a databank, which may include any number advertisements categorized within the category associated with the service, according to selection criteria. After the advertising announcement is completed, the directory assistance call is processed as usual.

### RELATED APPLICATION(S)

This application is a continuation in part of U.S. application Ser. No. 11/728,189, filed Mar. 23, 2007, which is a continuation of U.S. application Ser. No. 10/063,990, filed May 31, 2002, now issued as U.S. Pat. No. 7,212,615. The entire teachings of the above application(s) are incorporated herein by reference.

### BACKGROUND OF THE INVENTION

1. Field of the Invention

This invention relates to systems for providing telephone toll services such as, but not limited to, directory assistance or long-distance calling.

2. Description of Prior Art

The need for phone customers to locate the name, address and number of businesses such as airlines, floral shops and auto repair shops has been around for almost as long as the phone has been in existence.

Currently most phone systems charge extra for the look up of the names and addresses and numbers of general or specific businesses. This can get to be costly and many telephone customers find such directory assistance charges to be excessive.

There is also a current need for many businesses to market to a wide pool of consumers with targeted advertisement. This can be done efficiently through the use of SIC codes or “Standard Industry Codes.” By knowing exactly what a particular consumer is looking for at that particular moment a company can target their scope of interest with an ad.

The use of advertisements within a telephone system is well known in the art. U.S. Pat. No. 4,850,007 by Marino is for a “Telephone toll service with advertising”. It is a system for providing an economical telephone toll service in which a telephone subscriber selects the economical service by, for example, sending an appropriate signal, and then dials his directory assistance call or other telephone toll call. After the caller's options are determined, and typically before signaling for the call is commenced, a recorded-announcement of an aural or visual nature is connected to the subscriber's line, with the announcement consisting of at least one advertisement. The advertisements are selected from a databank according to some predetermined technique of selection, which may include any number of factors or features to make the service attractive to subscribers and of a nature to make the service also sufficiently rewarding to advertisers. The advertisement is not however, tied to the caller's specific interests or SIC code based on the number dialed.

U.S. Pat. No. 5,448,625 by Lederman is a “Telephone advertising method and apparatus.” It is a method and apparatus for routing a telephone call through a telephone network from a caller to a called party designated by the caller via advertising service apparatus that operates in two modes successively, the parties being in communication with each other in one mode and ads are selected from storage during that mode and the ads are impressed on one or both of the parties during a different mode. Selection of ad messages for use is controlled by many criteria. Delivery of the advertisements is recorded for accounting purposes. The modes may alternate between message intervals whose duration is determined by ad message length and communication intervals whose length is determined by a talking time timer. Still there is a need for better selection criteria.

U.S. Pat. No. 5,852,775 by Hidary is a “Cellular telephone advertising system.” It discloses a cellular telephone system, which is provided with an ad server and a memory for holding various commercial messages. The messages are either generic or are tailored for specific demographically selected subscribers or geographic cells. When communication is established either between a subscriber or a nonsubscriber, at least one of them receives either a generic or a specific commercial message. These advertisements are not geared to the needs of a particular caller.

U.S. Pat. No. 5,652,784 by Blen is an “Automatic telephone advertising provided in lieu of dial-tone.” This invention discloses a telephone advertising service providing a short advertising message through a telephone receiver as a telephone call is initiated. Several different messages are offered in different sets of channels, with the messages changing depending on the time of day. When a prohibit service signal is active, the subscriber line is switched directly to the telephone exchange. These messages are not targeted towards the interests of a particular caller.

There is still room for improvement within the art.

### SUMMARY OF THE INVENTION

It is a general object of the present invention to have a process that allows the cross marketing of phone customers when they ask for directory assistance.

The current invention is such that if a consumer is interested in airline tickets and they are calling Directory Assistance an ad based on their interest is played to that consumer. An airline or travel related ad will have a much higher impact and be received with a much higher level of interest with this consumer than to someone who is watching the evening news and is shown an airline ad.

By knowing exactly what a particular consumer is looking for at the moment they are looking; you can target their scope of interest with an ad. Using SIC code or “Standard Industry Code” or even some other variable such as having a live operator select which ad would be appropriate does this.

The concept is to use the information obtained in the 10 second listing request to play a targeted message and offer instant access to the product or service related to that message via “live call transfer” or “press 1 to be transferred to (the advertiser) now”.

For non-SIC code ads general, non-category specific ads such as “refinancing your home” or a home improvement ad can be played. These ads can be played based on the point of call. This can be done by setting up calls to be routed to a specific ad if the point of the caller's location is within a specific area code, zip code, city block or other parameter.

This would be helpful for companies like Home Depot, who might want to buy ad space in zip codes of “mostly owner occupied residences”, or pay day advance stores, who might want to buy advertisement for areas which are more economically depressed.

The type of ad and when the ad is played, can be controlled to a highly specific degree.

This system involves Point of call routing which is the routing an inbound 800 number call based on the location of the caller and routing the call to any predetermined location using zip code, area code, area code and prefix or city block maps.

Ads can be bought to target specific competitor names or industry codes. They can also be bought by markets delineated by zip code, area code city block or statewide.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a telephone toll system embodying the present invention;

FIG. 2 shows a block diagram of parts of the system involved with selecting the type of announcement connected to a particular subscriber's line;

FIG. 3 gives an example of Division Structure of SIC codes;

FIG. 4 gives an example of a Major Group of the SIC codes;

FIG. 5 is a schematic of the system; and

FIG. 6 gives a flowchart of the system.

FIGS. 7A-7D are diagrams illustrating different techniques that may be employed to send a request for information from and deliver results to a mobile device.

### DETAILED DESCRIPTION OF THE INVENTION

A description of example embodiments of the invention follows.

### Preferred Embodiment

The preferred embodiment of the invention is a process that allows the cross marketing of phone customers asking for directory assistance.

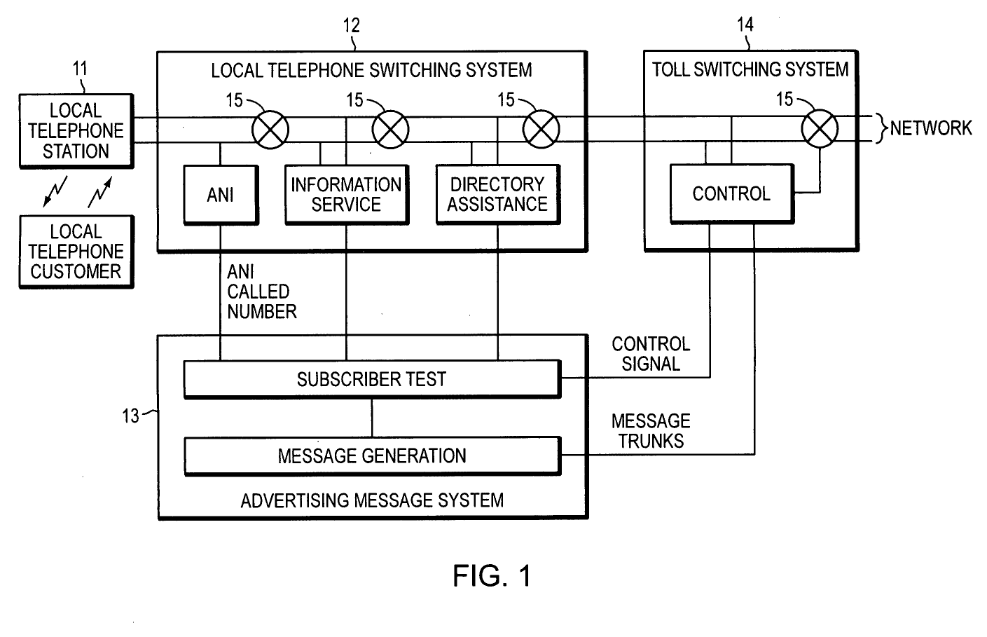

In FIG. 1, the local telephone station 11 is the typical telephone handset, in the usual case, and is connected by the typical local loop wires and connections to a local telephone switching system 12 which in turn connects through a toll switching system 14 to the total telephone network. Interconnected with the local telephone switching system 12 and the toll switching system 14 is the advertising message system 13 which is adapted to provide the directory assistance which has been generally summarized above.

In general, the local telephone station 11 is used by a local telephone customer, the User 10, indicated schematically.

The internal connections of the system are, in more detail, the following. The line from local telephone station 11 will be routed, through portions of switching elements 15, to the directory assistant module of the local switching system 12 if that is the nature of the customer's request, and in general, this may have been reached by dialing a specific phone number such as 1-800-Dealers.

It is anticipated that the broadest volume of use will result from long distance calling. The preferred embodiment will use a routing automatic number identification (ANI) within local telephone switching system 12, together with the subscriber test equipment in advertising message system 13, will identify the local customer in question as being one who wants to receive reduced directory assistance or long distance calling so that his incoming line will automatically be connected to advertising message system 13 before his toll call is completed.

In all of the foregoing situations identified in local telephone switching system 12, the result will be that a signal is sent to advertising message system 13 which results in a control signal being sent to toll switching system 12 to switching elements 16 to prevent the further progress of the user's call until the new features of this toll service have been provided. Therefore, at this point, the local telephone subscriber is not in contact with the larger telephone network.

In point of fact, this message may be of either an aural or visual nature, especially if the local subscriber has made available a monitor or television set connected to his telephone line. When this message ends, the control network within toll switching system 14 then removes the block on the signaling for the toll call and the call goes out over the network in the usual fashion.

The current invention is as follows if a consumer is interested in airline tickets RIGHT NOW and they are calling Directory Assistance the correct ad played to that consumer, an airline or travel related ad, will have a much higher impact and be received with a much higher level of interest than to someone who is watching the evening news and is shown an airline ad.

By knowing exactly what a particular consumer is looking for at the moment they are looking you can target their scope of interest with an ad. Using SIC code or “Standard Industry Code” or even some other variable such as having a live operator select which ad would be appropriate does this.

The concept is to use the information obtained in the 10 second listing request to play a targeted message and offer instant access to the product or service related to that message via “live call transfer” or “press 1 to be transferred to (the advertiser) now”.

For non SIC code ads general, non-category specific ads such as “refinancing your home” or a home improvement ad can be played. These ads can be played based on the point of call. This can be done by setting up calls to be routed to a specific advertisement if the point of the callers location is within a specific area code, zip code, city block or other parameter.

This would be helpful for companies like Home Depot, who might want to buy ad space in zip codes of “mostly owner occupied residences” or pay day advance stores which may want to purchase advertisement for areas that are more economically depressed.

The type of ad and when the ad is played can be controlled to a highly specific degree.

In the preferred embodiment the system will use Point of call routing, which is the routing of an inbound 800 number call based on the location of the caller and connecting that caller to any predetermined location using zip code, area code, area code and prefix or city block maps.

Ads can be bought to target specific competitor names or industry codes. They can also be bought by markets delineated by zip code, area code city block or statewide.

The advertisements could also have been chosen on a random basis, or they could have been chosen to provide sufficient exposure to each of the advertisers who provided the ads for this service. In any event these advertisements will be stored in a large-scale mass memory or memory means.

In all of the foregoing versions of the service, it should be apparent that the interactive logic could be extended to make it possible for the customer to indicate, e.g., by dialing appropriate digits, that he wishes written material to be sent to him or that he wishes to talk to a salesman—now or later.

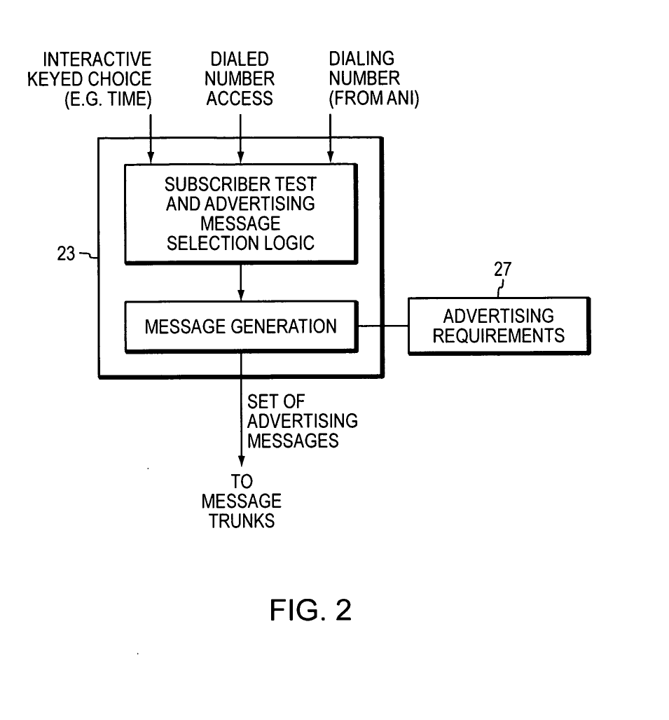

We have attempted to lay out in FIG. 2 a chart illustrating most of the foregoing message choice criteria in a logical manner.

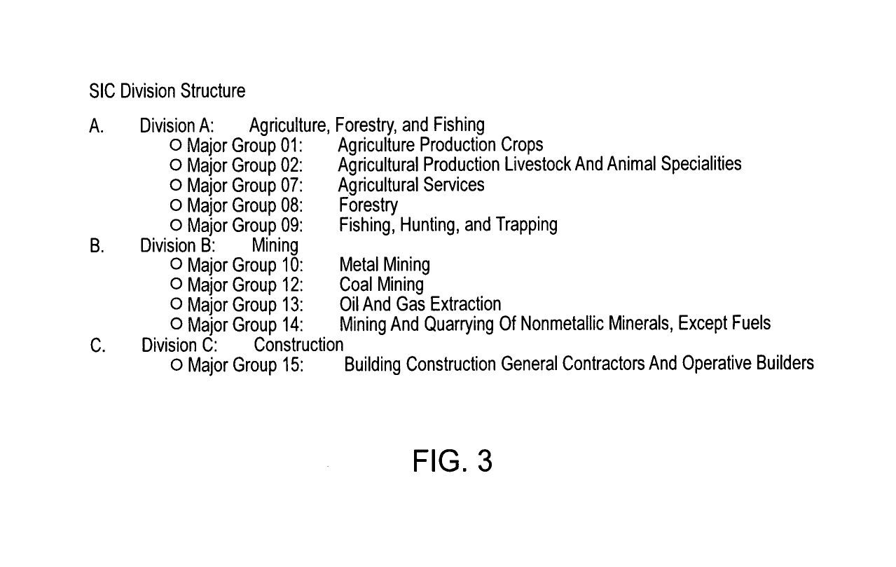

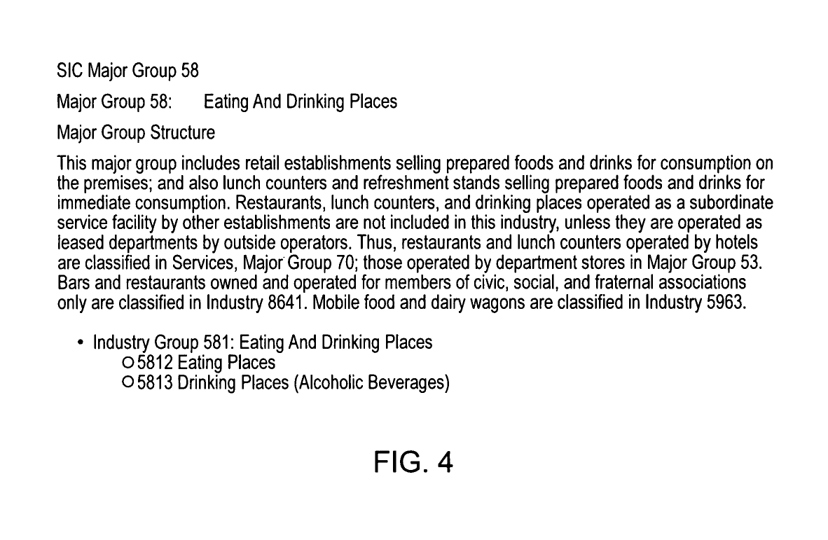

We have disclosed a sample of the SIC Division Structure in FIG. 3 and the SIC Major Group 58 in FIG. 4 to display the industry standard codes that can be used in the selection process.

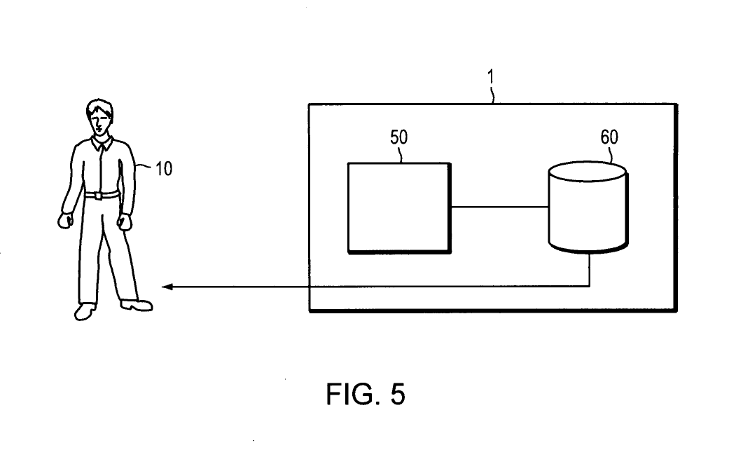

FIG. 5 is a schematic of how system 1 works. The User 10 calls and is connected to a directory assistance number. The User 10 requests a number or a type of service or good, the system uses this as part of the selection criteria which is used by a selection means 50 such as a computer processor and selects an advertisement from the database 60 and the advertisement is played back to the User 10.

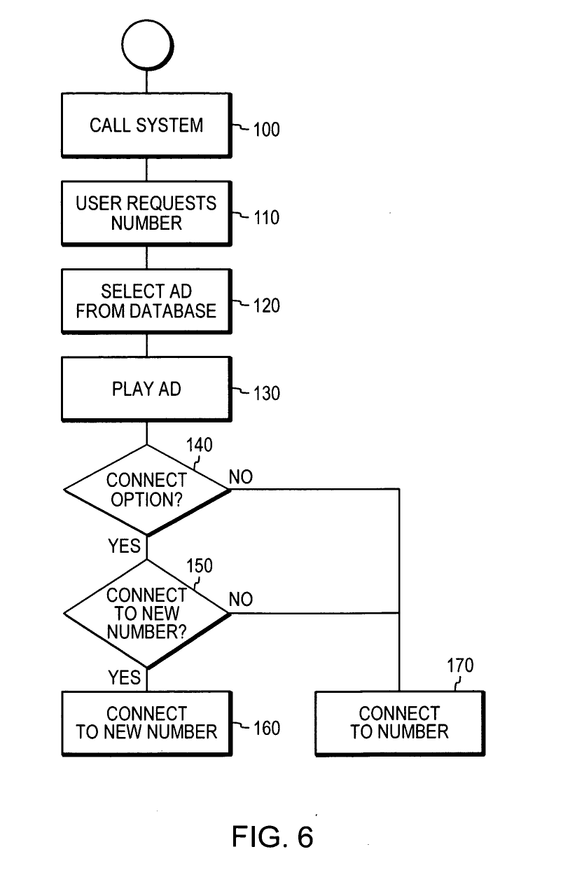

FIG. 6 is a basic flowchart of the process. In Step 100, the User 10 calls the system 1. The User 10 then requests a specific number of a company or a type of goods or services in Step 110. The system 1 uses the request, along with additional information such as the locations from where call was placed and other targeting information to select an ad from the advertising database 60 in step 120. The system 1 retrieves the ad and plays it for the User 10 in step 130. In step 140, the system 1 asks “is there a connection option for this ad?” If yes, the User 10 is asked if they want to opt to be connected to the advertiser's number 150. If yes, the User 10 is connected to the advertiser's number 160. If no, the User 10 is connected to their selected number 170. If there is no connection option for this ad, the User 10 is connected to their selected number 170.

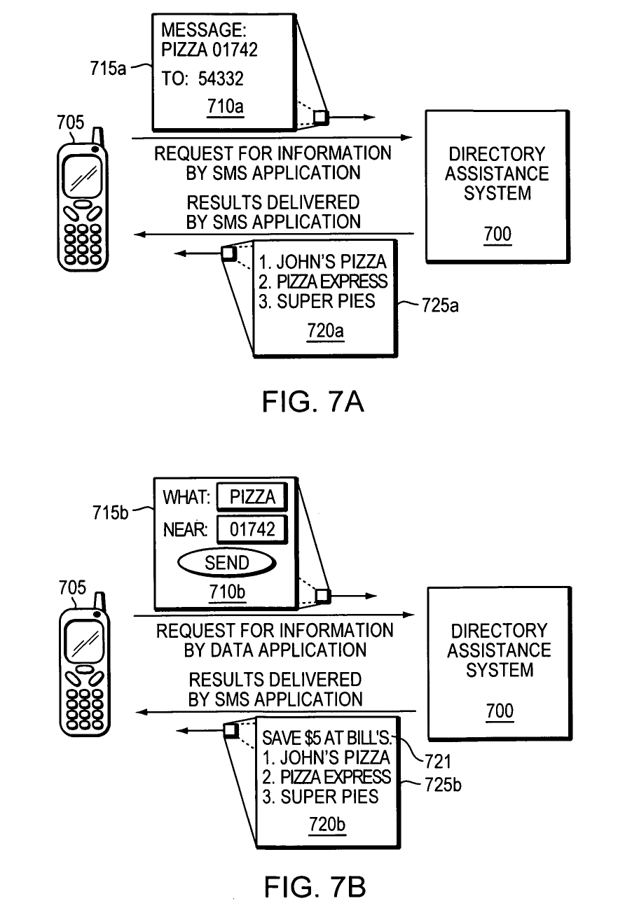

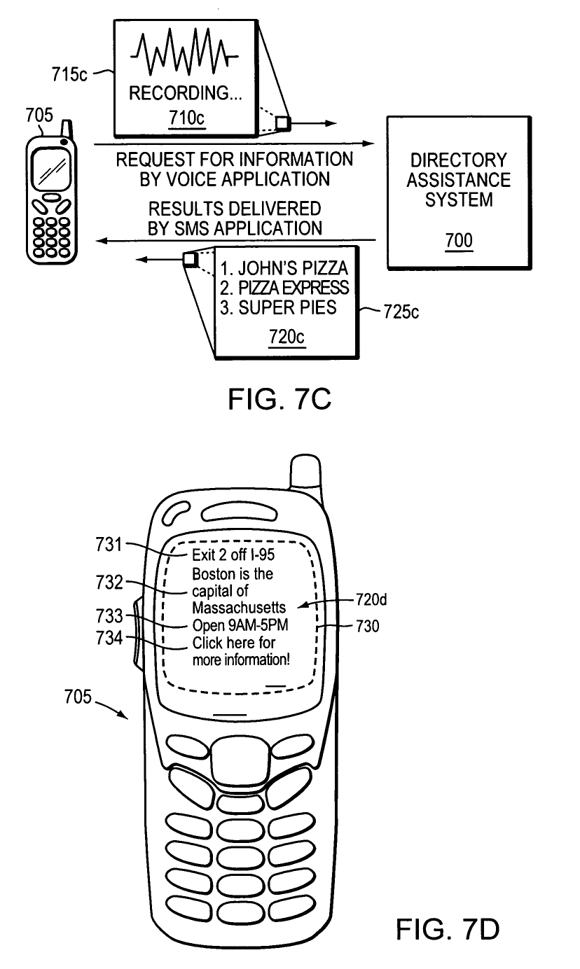

FIGS. 7A-7C illustrate embodiments in which the directory assistance system 700 is accessed by a wireless device 705, such as a cellular telephone. As illustrated in FIG. 7A, the request for information 710a may come via short message service (SMS) application 715a, with the results 720a of the directory assistance likewise being delivered by SMS application 725a.

Moreover, as illustrated in FIG. 7B, the consumer's request 710b for a specific business or business category may be sent via a data application 715b running on the mobile device 705 that communicates the request 710b to the system 700, with the returned results 720b including one or more advertisements 721 displayed on the mobile device 705 by SMS 725b. The consumer may then choose an advertisement 721 through a gesture, such as by clicking the advertisement with a stylus.

Finally, as illustrated in FIG. 7C, the request for information 710c may be sent via one form, such as voice 715c, with the result 720c returned in another form, such as SMS 725c. In this manner, a consumer may make its request for information 710c in a user-friendly form 715c, and receive the requested information 720c in a form 725c that may be repeatedly referred to or saved for future reference.

As illustrated in FIG. 7D, the results 720d delivered by SMS 725d may also contain additional data 730, such as driving directions 731, additional information about a geographic area 732, or business hours 733, with this additional information optionally being available via a hyperlink 734 embedded into the SMS message 725d.

### Additional Embodiment

This system could also be used in a wireless environment with Handheld PCs or an Internet or chat environment.

### Advantages

The current invention provides much needed inexpensive directory assistance. The user calls a unique number for directory assistance, an operator answers that call and asks the user of his/her desired phone number, the system then uses this phone number as one of the basis for the selection criteria to select an advertisement for the system to play for the user. After the user listens to the advertisement, the system will provide the user with the desired phone number. The system may have the option for the user to select on or contact another company for the service.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method for providing directory assistance information in a public telecommunication network, the network comprising a customer station and a data processing station, the method comprising:
at the customer station,
initiating a request to the data processing station to set up a data connection from the customer station to the data processing station;
providing a request for information for a provider of goods or services;
at the data processing station,
receiving the request for information from the customer station;
examining the request for information to identify a category associated with the specific provider of goods or services;
selecting an at least one advertisement categorized within the category;
retrieving the selected at least one advertisement from a stored media;
forwarding the selected at least one advertisement to the customer station; and
at the customer station, receiving the selected at least one advertisement.

2. The method of claim 1, wherein the request for information is provided by a data application running at the customer station.

3. The method of claim 1, wherein the request for information is provided by short message service (SMS).

4. The method of claim 1 further comprising, at the customer station, choosing one of the one or more selected advertisements.

5. The method of claim 1, further comprising:
querying a database for selecting the advertisement.

6. The method of claim 1, further comprising:
causing the advertisement to be played to the customer station in a visual form.

7. The method of claim 6, wherein the visual form is a video form.

8. The method of claim 6, wherein the visual form is an SMS text message.

9. The method of claim 8 wherein the SMS text message contains a hyperlink or similar executable command to retrieve additional information regarding the specific provider of goods or services.

10. The method of claim 1, further comprising:
providing access to a service associated with the selected advertisement.

11. The method of claim 10, further comprising:
connecting the customer station to a telephone number associated with the selected advertisement.

12. A system comprising:
a customer station including data connection circuitry; and
a data processing station that operates to receive a request for directory assistance information from the customer station, to examine the request for directory assistance information to identify a category associated with a specific provider of goods or services, to automatically select an at least one advertisement from a plurality of advertisements categorized within the category, to retrieve the selected at least advertisement from a stored media, and to forward the selected at least one advertisement to the customer station.

13. The system of claim 12, the customer station further comprising:
an input device to obtain a data input used for accessing the data processing station;
a transmitter that operates to transmit the request for directory assistance information, wherein the data connection circuitry operates to set up a data connection from the customer station to the data processing station; and
a first a receiver that operates to receive the selected advertisement.

14. The system of claim 13, the data processing station further comprising:
a second receiver that operates to receive the request for directory assistance information from the customer station; and
a processor that operates to retrieve the selected at least one advertisement from a stored media.

15. The system of claim 12, further comprising:
a database apparatus that operates to process a query to determine the selected at least one advertisement, the query having at least one query parameter derived from the request for directory assistance information.

16. The system of claim 12, wherein the request for information is received from a data application running at the customer station.

17. The system of claim 12, wherein the request for information is received by SMS.

18. The system of claim 12, further comprising:
a selection apparatus to choose one advertisement from the at least one advertisement.

19. The system of claim 17, wherein the textual SMS form contains a hyperlink or similar executable command to retrieve additional information regarding the specific provider of goods or services.

20. The system of claim 12, wherein the call processing station further provides access to a service associated with the selected advertisement.

21. The system of claim 20, wherein the customer station is selectively connected to a telephone number associated with the selected advertisement.

22. The system of claim 21, wherein the customer station is connected to the service provider associated with the selected advertisement only after prompting a user.

23. The system of claim 12, wherein the customer station is selectively connected to a telephone number for the specific provider associated with the request for information.
